(19) United States
(12) Patent Application Publication
(10) Pub. No.: US 2024/0045072 A1
(43) Pub. Date: Feb. 8, 2024

(54) LASER DETECTION SYSTEM AND VEHICLE HAVING SAME

(71) Applicant: HON HAI PRECISION INDUSTRY CO., LTD., New Taipei (TW)

(72) Inventors: KUO-FONG TSENG, New Taipei (TW); SHAO-WEI YANG, New Taipei (TW)

(21) Appl. No.: 18/229,195

(22) Filed: Aug. 2, 2023

(30) Foreign Application Priority Data
Aug. 4, 2022 (CN) 202210933939.8

(51) Int. Cl. G01S 17/931; G01S 7/481

(52) U.S. Cl. CPC G01S 17/931; G01S 7/4814; G01S 7/4817

(57) ABSTRACT

A laser detection system includes a light source module, an optical isolator, a scanner, and a detector. The light source module is configured for emitting a first laser having a first polarization direction. The optical isolator is on an optical path of the first laser configured to emit a second laser by transmitting the first laser from the light source module and prevent the second laser from transmitting toward the light source module. The scanner is on an optical path of the second laser and configured for reflecting the second laser to project a reference light to the target to be tested. The detector is configured to receive detection light reflected by the target to be tested and obtain position information of the target to be tested according to the detection light.

### FIELD

The subject matter herein generally relates to a field of laser detection technology, particularly relates to a laser detection system and a vehicle having the laser detection system.

### BACKGROUND

A conventional laser detection system includes a light source, a spectroscope, and a detector. The light source is configured to emit detection light to the spectroscope. Guiding all the detection light incident on the spectroscope to a detectable object is almost impossible, so a small part of the detection light is scattered multiple times in the laser detection system. For the detector, some of the detection light scattered many times may return to the light source again, causing interference to the light source, and possibly being incident on the detector, affecting the result of the detector. Therefore, there is room for improvement in the art.

### BRIEF DESCRIPTION OF THE DRAWINGS

Implementations of the present technology will now be described, by way of embodiments only, with reference to the attached figures.

FIG. 1 is a schematic view showing a vehicle and a test target according to an embodiment of the present disclosure.

FIG. 2 is a view of a laser detection system of FIG. 1.

FIG. 3 is a view of a wave plate assembly of FIG. 2.

FIG. 4 is a view of a light blocking element of FIG. 2.

FIG. 5 is a view of an optical isolator of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as coupled, whether directly or indirectly through intervening components, and is not necessarily limited to physical connections. The connection can be such that the objects are permanently coupled or releasably coupled. The term “comprising” when utilized, means “including, but not necessarily limited to”; it specifically indicates open-ended inclusion or membership in the so-described combination, group, series, and the like.

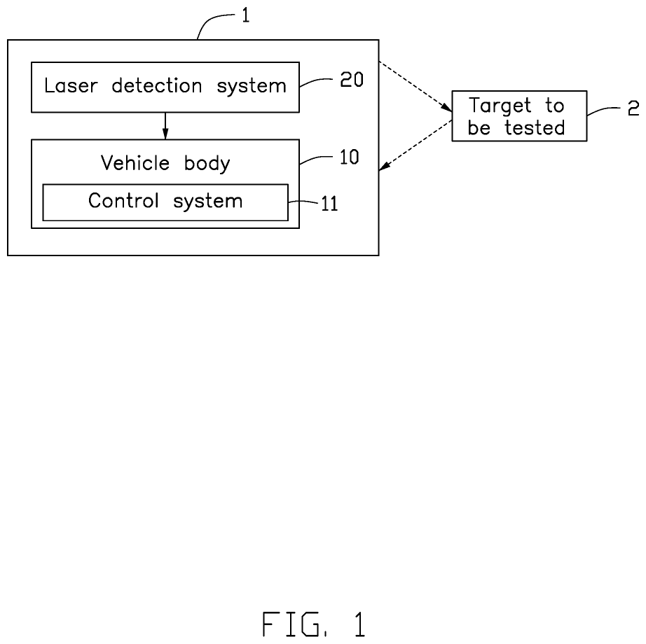

FIG. 1 illustrates a vehicle 1. The vehicle 1 includes a vehicle body 10 and the laser detection system 20 fixed on the vehicle body 10.

Obstacles or potential obstacles (hereinafter referred to as target 2) may appear in a traveling direction of vehicle 1. If vehicle 1 collides with an actual obstacle, the consequences may be severe. When the vehicle 1 is moving, the laser detection system 20 is configured to continuously detect whether there is a target 2 in the moving path of the vehicle 1. When a target 2 is detected, the laser detection system 20 is also configured to obtain position information of the target 2. In this embodiment, the position information includes a distance between the target 2 and the vehicle 1 and its orientation of the target 2 relative to the vehicle 1. The vehicle body 10 also includes a control system 11, which can communicate with the laser detection system 20. When the laser detection system 20 obtains the position information of the target 2, the control system 11 can warn the driver to pay attention to the target 2 in a preset way (such as images or voice). Therefore, the laser detection system 20 in the present disclosure warns the driver of the road conditions when the vehicle 1 is moving, thereby helping to avoid accidents.

In another embodiment of the present disclosure, the vehicle 1 is an unmanned vehicle. In this embodiment, the control system 11 is configured to control the automatic driving vehicle body 10 according to the position information of the target 2 to be tested obtained by the laser detection system 20 to drive along a preset path and avoid the targets 2.

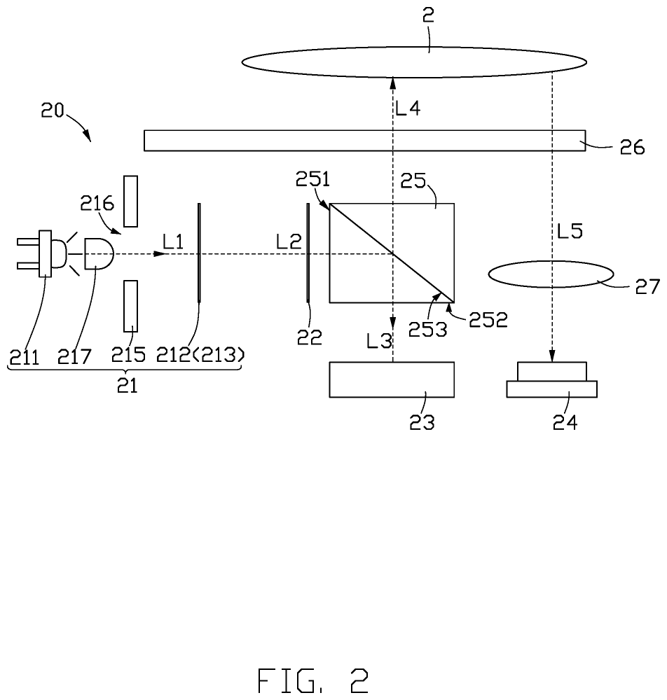

FIG. 2 illustrates the laser detection system 20. The laser detection system 20 includes a light source module 21, an optical isolator 22, a scanner 23, and a detector 24.

In this embodiment, the light source module 21 includes a laser source 211 and a wave plate assembly 212.

The laser source 211 is configured for emitting source light L1. In this embodiment, the laser source 211 includes at least one laser diode for emitting infrared laser. In other embodiments, the laser source 211 may also include at least one laser. In this embodiment, a part of the source light L1 has a first polarization direction and other part of the source light L1 has a second polarization direction. That is, a part of the source light L1 is P polarized light, and other part of the source light L1 is S polarized light.

The wave plate assembly 212 is on the optical path of the source light L1. The wave plate assembly 212 is configured to receive the source light L1 and reverse or convert the polarization direction of the source light L1. That is, when the source light L1 having the first polarization direction is incident on the wave plate assembly 212, the wave plate assembly 212 converts the source light L1 to have the second polarization direction. When the source light L1 having the second polarization direction is incident on the wave plate assembly 212, the wave plate assembly 212 converts the source light L1 to have the first polarization direction. In other words, the wave plate assembly 212 is configured to convert the P polarized light into the S polarized light and convert the S polarized light into the P polarized light.

In this embodiment, the structural characteristics of the laser source 211 itself are such that the amount of the S polarized light in the source light L1 emitted by the laser source 211 is far more than an amount of the P polarized light (98% is the S polarized light and 2% is the P polarized light), but it is the P polarized light which is mainly used in the subsequent optical path. Therefore, in this embodiment, the polarization direction of the source light L1 is converted by the wave plate assembly 212, so that almost all the light passing through the wave plate assembly 212 is P polarized light, which can be used in the subsequent optical path. Therefore, the wave plate assembly 212 improves the light utilization ratio.

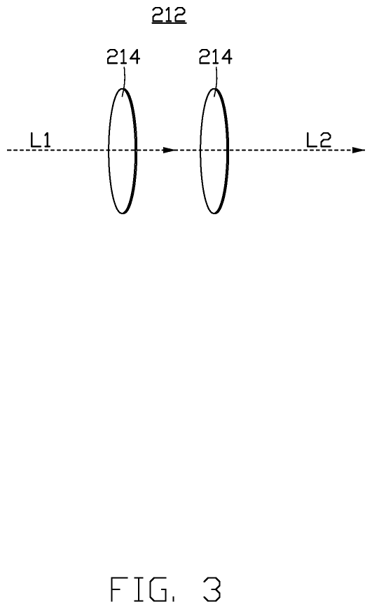

In this embodiment, the wave plate assembly 212 includes a half wave plate 213. In other embodiments, as shown in FIG. 3, the wave plate assembly 212 may also include two quarter wave plates 214 arranged in sequence.

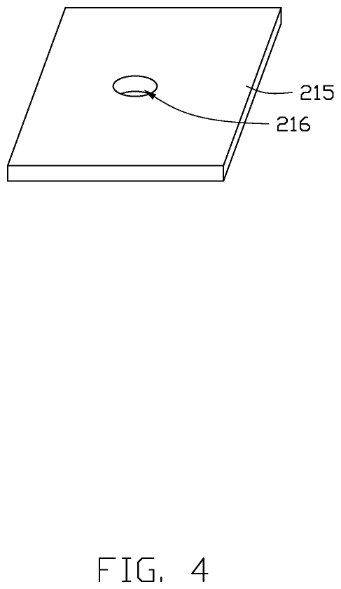

In this embodiment, the light source module 21 also includes a light blocking element 215. The light blocking element 215 is located between the laser source 211 and the wave plate assembly 212. As shown in FIG. 4, in this embodiment, the light blocking element 215 includes a flat plate as light shielding material, the flat plate defining a through hole 216 near a center area (geometric center, such as a center of a circle, a diagonal intersection of a square) of the light blocking element 215. The through hole 216 of the light blocking element 215 is aligned with the laser source 211, so that the source light L1 can be transmitted through the through hole 216.

In this embodiment, after the source light L1 is emitted from the light source module 21, a part of the source light L1 is used in the subsequent optical path to realize laser detection. The other part of the source light L1 is difficult to be used as laser detection and is lost due to propagation among the optical elements of the laser detection system 20, such lost light being hereinafter referred to as stray light. In propagation, the stray light may be incident on the laser source 211 and cause interference.

In this embodiment, the through hole 216 in the light blocking element 215 is a circular hole, and its size is set according to a size of the laser source 211. The size of the through hole 216 is slightly larger than the size of the laser source 211. In this way, as much as possible of the source light L1 passes through the through hole 216. In addition, since the light blocking element 215 includes the light blocking material, the stray light otherwise incident on the light source module 21 will be blocked by the light blocking element 215. To reach or get back to the laser source 211, the stray light must pass through the light hole 216, and stray light is disordered, the probability and amount of stray light passing through the light hole 216 is very small. Therefore, the light blocking element 215 in this embodiment can to a certain extent avoid light interference caused by the stray light incident on the laser source 211.

As shown in FIG. 2, in this embodiment, the light source module 21 also includes a collimating element 217. The collimating element 217 is located between the laser source 211 and the light blocking element 215, and on the optical path of the source light L1. It is configured to collimate the source light L1 from the laser source 211, so as to reduce the angle of divergence of light from the laser source 211 and guide the source light L1 to pass through the through hole 216. If the source light L1 does not pass through the light passage hole 216, it will be lost. Therefore, the collimating element 217 is conducive to improving the utilization ratio of the source light L1.

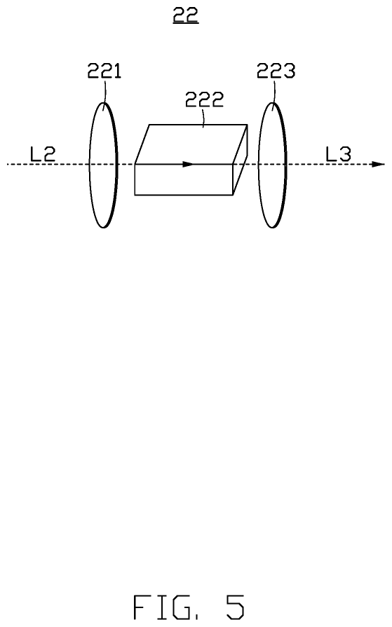

As shown in FIG. 5, in this embodiment, the light emitted from the wave plate assembly 212 is defined as the first laser L2. The optical isolator 22 is located on the optical path of the first laser L2 and is configured to receive the first laser L2 and emit a second laser L3 according to the first laser L2. The second laser L3 is rotated 45° relative to the polarization direction of the first laser L2.

In this embodiment, the optical isolator 22 includes a polarizer 221, a Faraday rotator 222, and a polarizer 223. The polarizer 221, the Faraday rotator 222, and the polarizer 223 are successively located on the optical path of the first laser L2. The first laser L2 is converted into linearly polarized light after passing through the polarizer 221. When going through the Faraday rotator 222, the polarization direction of the first laser L2 is rotated by 45°. An angle between the polarizer 223 and the polarizer 221 is 45°, and the first laser L2 after the polarization direction is rotated is just able to pass through the polarizer 223. The light passing through the polarizer 223 is defined as the second laser L3 described above.

The second laser L3 emitted from the polarizer 223 may be partially lost when propagating in the subsequent optical path. The lost portion may return to the optical isolator 22 as stray light. When stray light moves toward the optical isolator 22, it successively passes through the polarizer 223, the Faraday rotator 222, and the polarizer 221. At this time, only stray light parallel to the direction of the polarizer 223 can pass through the polarizer 223 and become incident on the Faraday rotator 222. When the stray light is actually incident on the Faraday rotator 222, its polarization direction will be rotated by 45°. As mentioned above, an included angle between the polarizer 223 and the polarizer 221 is 45°, and the stray light is rotated by 45°, so the included angle between the stray light emitted from the Faraday rotator 222 and the polarizer 221 is 90°. That is, the stray light emitted from the Faraday rotator 222 is perpendicular to the polarizer 221 and thus will be blocked by the polarizer 221, and will not be able to continue towards the light source module 21. Therefore, in this embodiment, because of the optical isolator 22, stray light can be prevented from entering or getting back to the light source module 21 and causing interference.

As shown in FIG. 2, the scanner 23 is located on the optical path of the second laser L3 and is configured to reflect the received second laser L3. In this embodiment, the scanner 23 is also configured to diffract the received second laser L3 to generate a reference light L4, the reference light L4 is structured light. The scanner 23 in this embodiment is an electrically driven scanner. That is, by changing a voltage value applied to the scanner 23, the rotation angle of the scanner 23 can be changed. By changing the rotation angle of the scanner 23, a phase of the light reflected by the scanner 23 can be modulated, so that the modulated light interferes to generate corresponding structured light (i.e., reference light L4).

As mentioned above, the laser detection system 20 of the disclosure is applied to the vehicle 1. That is, the laser detection system 20 is a vehicle mounted laser detection system. The frequent bumping and vibration during movement of the vehicle requires an effective damping and anti-vibration performance of the scanner 23. Existing mechanically driven scanners 23 are prone to jitter and deflection, while the electrically driven scanner 23 of the disclosure is conducive to improving the working stability of the scanner 23.

In this embodiment, the laser detection system 20 also includes a beam splitter 25. The beam splitter 25 is located on the optical path of the second laser L3 and is configured to guide the second laser L3 to the scanner 23. The beam splitter 25 is also located on the optical path of the reference light L4 and is configured to guide the reference light L4 to the target 2. The beam splitter 25 has a first light inlet surface 251, a second light inlet surface 252 at a right angle thereto, and a light splitter surface 253. In this embodiment, the second laser L3 is vertically incident from the first light inlet surface 251, and the reference light L4 is vertically incident from the second light inlet surface 252. In this embodiment, when the second laser L3 is incident on the light splitter surface 253, a part of the second laser L3 is reflected to the scanner 23, and the other part of the second laser L3 is transmitted from the light splitter surface 253 along the original optical path. When the reference light L4 is incident on the light splitter surface 253, a part of the reference light L4 is reflected, and the other part of the reference light L4 is transmitted from the light splitter surface 253 along the original light path.

Furthermore, the scanner 23 is also configured to guide the reference light L4 to the target 2 by the beam splitter 25. When the reference light L4 shines on the target 2, it will be reflected by the target 2. In this embodiment, light reflected by the target 2 is defined as detection light L5.

In this embodiment, the detector 24 is located on the optical path of the detection light L5 and configured to receive the detection light L5 and thereby obtain the position information of the target 2 according to the detection light L5. In this embodiment, the detector 24 includes a plurality of photoelectric elements (not shown). Each photoelectric element is configured to perform photoelectric conversion when receiving the detection light L5 to generate an electrical signal, and the electrical signal can be analyzed for calculating the position information of the target 2.

In this embodiment, the laser detection system 20 also includes a filter 26. The filter 26 is located on the optical path of the detection light L5 and is configured to filter out ambient light. As mentioned above, the detector 24 is configured to obtain the position information of the target 2 to be tested according to the received detection light L5. The light incident on the detector 24 may include the detection light L5 and some ambient light (the light in the environment where the laser detection system 20 is located). However, when the detector 24 receives the ambient light, the calculation of position of the target 2 may be subject to error. Therefore, in this embodiment, the ambient light is filtered out by the filter 26, which is conducive to improving an accuracy of the position information obtained by the detector 24.

In this embodiment, the laser detection system 20 also includes a focusing lens 27. The focusing lens 27 is located on the optical path of the detection light L5 and is between the filter 26 and the detector 24. Due to large divergence angles of the detection light L5 reflected by the target 2, much of the detection light L5 will not reach the detector 24. In this embodiment, by setting the focusing lens 27 to focus the detection light L5 to the detector 24, it is beneficial to improve light utilization of the detection light L5, and thus to improve the accuracy of the position information.

In the laser detection system 20 of the present disclosure, the beam splitter 25 is used for reflecting a part of the second laser L3 and transmitting a part of the reference light L4, and also for transmitting other part of the second laser L3 and reflecting other part of the reference light L4. Thus a part of the second laser L3 transmitted by the beam splitter 25 and a part of the reference light L4 reflected by the beam splitter 25 are not utilized for laser detection in the subsequent optical path, and will be lost. Some of the lost parts of light might propagate in the laser detection system 20 as stray light, and even cause interference of the light source module 21 if not blocked.

The optical isolator 22 thus allows the first laser L1 to be transmitted from the optical isolator 22 and applied to the subsequent laser detection process. But the stray light, including the lost parts of light, is not able to pass through the optical isolator 22, and light interference caused by the stray light incident on the light source module 21 is avoided.

Furthermore, in this embodiment, the light blocking element 215 serves to prevent or at least limit the stray light otherwise incident on the laser source 211 physically.

The laser detection system 20 and the vehicle 1 applying the laser detection system 20 of the present disclosure have improved accuracy and speed in determining the position of obstacles and potential obstacles in front of a moving vehicle.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A laser detection system comprising:
a light source module configured for emitting a first laser having a first polarization direction;
an optical isolator, the optical isolator being on an optical path of the first laser, the optical isolator configured to emit a second laser by transmitting the first laser from the light source module and prevent the second laser from transmitting toward the light source module;
a scanner on an optical path of the second laser and configured for reflecting the second laser to project a reference light to a target; and
a detector configured to receive detection light reflected by the target and obtain position information of the target according to the detection light.

2. The laser detection system of claim 1, wherein the light source module comprises:
a laser source for emitting source light; and
a wave plate assembly on the optical path of the source light and configured to convert at least a part of the source light into the first laser having a first polarization direction.

3. The laser detection system of claim 2, wherein the wave plate assembly comprises a half wave plate.

4. The laser detection system of claim 2, wherein the wave plate assembly comprises two quarter wave plates arranged in sequence.

5. The laser detection system of claim 2, wherein the light source module further comprises:
a light blocking element between the laser source and the wave plate assembly, wherein
the light blocking element is made of light shielding material and defines a through hole positioned to transmit the source light.

6. The laser detection system of claim 1, wherein the first laser is P polarized light.

7. The laser detection system of claim 1, further comprising a beam splitter located on the optical path of the second laser and configured for guiding a part of the second laser to the scanner and guiding a part of the reference light to the target.

8. The laser detection system of claim 1, wherein the scanner is further configured to diffract the second laser, and the reference light is structured light.

9. The laser detection system of claim 1, wherein the scanner is an electrically driven scanner.

10. The laser detection system of claim 1, further comprising a filter, wherein the filter is located on the optical path of the detection light, the filter is configured to filter ambient light.

11. A vehicle, comprising:
a vehicle body;
a laser detection system fixed on the vehicle body, the laser detection system being configured to detect if a target is on a moving path of the vehicle body and obtain position information of the target when the target on the moving path of the vehicle body to is detected,
the laser detection system comprising:
a light source module configured for emitting a first laser having a first polarization direction;
an optical isolator, the optical isolator being on an optical path of the first laser, the optical isolator configured to emit a second laser by transmitting the first laser from the light source module and prevent the second laser from transmitting toward the light source module;
a scanner on an optical path of the second laser and configured for reflecting the second laser to project a reference light to the target to be tested; and
a detector configured to receive detection light reflected by the target to be tested and obtain position information of the target to be tested according to the detection light.

12. The vehicle of claim 11, wherein the light source module comprises:
a laser source for emitting source light; and
a wave plate assembly on the optical path of the source light and configured to convert at least a part of the source light into the first laser having a first polarization direction.

13. The vehicle of claim 12, wherein the wave plate assembly comprises a half wave plate.

14. The vehicle of claim 12, wherein the wave plate assembly comprises two quarter wave plates arranged in sequence.

15. The vehicle of claim 12, wherein the light source module further comprises:
a light blocking element between the laser source and the wave plate assembly, wherein
the light blocking element is made of light shielding material and defines a through hole positioned to transmit the source light.

16. The vehicle of claim 11, wherein the first laser is P polarized light.

17. The vehicle of claim 11, further comprising a beam splitter located on the optical path of the second laser and configured for guiding a part of the second laser to the scanner and guiding a part of the reference light to the target.

18. The vehicle of claim 11, wherein the scanner is further configured to diffract the second laser, and the reference light is structured light.

19. The vehicle of claim 11, wherein the scanner is an electrically driven scanner.

20. The vehicle of claim 11, further comprising a filter, wherein the filter is located on the optical path of the detection light, the filter is configured to filter the ambient light.
